(19) United States
(12) Patent Application Publication
(10) Pub. No.: US 2009/0104709 A1
(43) Pub. Date: Apr. 23, 2009

(54) FLUID TRANSFER DEVICES

(75) Inventors: Robert C. Haushalter, Los Gatos, CA (US); Srinivas Vetcha, Sunnyvale, CA (US)

Correspondence Address: DUANE MORRIS LLP - Princeton, PO BOX 5203, PRINCETON, NJ, 08543-5203, US

(73) Assignee: PARALLEL SYNTHESIS TECHNOLOGIES, Santa Clara, CA (US)

(21) Appl. No.: 12/293,989

(22) PCT Filed: Mar. 23, 2007
(86) PCT No.: PCT/US07/64850

§ 371 Date: Dec. 29, 2008

Related U.S. Application Data
(60) Provisional application No. 60/784,901, filed on Mar. 23, 2006.

(51) Int. Cl. G01N 30/16; B01L 3/02; B44C 1/22

(52) U.S. Cl. 436/161; 73/864.02; 73/864.01; 216/41; 264/220

(57) ABSTRACT

A fluid transfer device includes a body and a sample holding reservoir formed in the body. The sample holding reservoir is capable of imbibing a fixed and very small quantity of fluid from a fluid source and dispensing the fixed quantity of fluid therefrom at a destination. The fluid transfer device may be manufactured from various materials including semiconductor materials such as silicon, polymer materials, ceramic material, and metal or metallic materials. The fluid transfer device may be used to puncture a closure covering the fluid source or the destination.

### RELATED APPLICATIONS

This application claims the benefit of U.S. Provisional Application No. 60/784,901, filed on Mar. 23, 2006, the entire disclosure of which is incorporated herein by reference.

### FIELD OF THE INVENTION

This invention relates to fluid transfer. More particularly, the invention relates to devices and methods for fluid transfer.

### BACKGROUND OF THE INVENTION

Most processes in research laboratories involve manipulating fluids, thus it is inevitable that as the demand for therapeutics increases, so does the need for precise, high-throughput fluid handling capabilities. Although technology for fluid manipulation has continually improved, there is still a dearth of devices that can accurately and inexpensively dispense fluid voles in the sub-microliter (μL) range.

At present, it is estimated that approximately 10% of the drug research market for fluid handling involves volumes of 500 μL or less. This segment of the market, however, is expected to grow rapidly, as the scale and speed of drug development and the need for assay miniaturization continues to evolve.

One of the most active areas of research in the pharmaceutical and biotechnology industries is drug discovery. Many companies manage large libraries of chemical compounds that are screened and evaluated for potency in variety of biological processes. In addition to the testing, the maintenance of these vast collections alone requires incredible amounts of fluid handling. For example, it is reported that for only 3-4 assays, it would take a technician 4 to 8 months to screen a library of 200,000 compounds in a 96 well format. Any advances that can reduce the time or materials needed for these applications will engender substantive improvements in productivity and efficiency.

The majority of devices on the market for high-throughput sub-microliter volume manipulation involve non-contact dispensing methodologies, as show in Table 1 below. There are several competing devices with fundamentally different operating principles, each with its own associated hardware and/or software. Although these devices offer precision volume dispensing and high throughput capabilities, the cost of purchase and maintenance are beyond the means of any but the most well funded research facilities.

Alternatively, there are passive fluid transfer devices, usually manufactured from metal or metal alloys, which can be used to transfer sub-microliter volumes in a high-throughput manner. These devices, however, also have disadvantages, primarily because they are manufactured in a serial, one-at-a-time process and subsequently hand-tested and binned in order to be calibrated for accurate volume uptake. Furthermore, these devices are difficult to clean, are susceptible to damage, and must be manufactured in a serial process (one-at-a-time), which significantly increases their cost.

TABLE 1
Various Small Volume Microfluidic Transfer Technologies

| | | |
|---|---|---|
| Technology | Working Range | % CV |

| | | | |
|---|---|---|---|
| Positive | 50-1,200 | nL | 8% |
| displacement | | | |
| pipette. | | | |
| Acoustic | 2.5-250 | nL | <8% |
| energy bursts. | | | |
| Glass | 25-1,000 | nL | <10% |
| capillaries. | | | |
| Microsolenoid/ | 5-60,000 | nL | 5-10% |
| hybrid valves. | | | |
| Piezoelectric | 0.5-3,000 | nL | <5% |
| valve. | | | |
| Pin tools. | 0.2-5,000 | nL | <10% |

Another issue at the forefront of compound library distribution and management relates to the nature of the drugs and reagents to be manipulated. Some of the drugs and reagents are viscous and contain dimethyl sulfoxide (DMSO). If too much reagent adheres to the fluid transfer device, the resulting concentrations of distributed components will be different than what was anticipated. Not only could this lead to errors in data interpretation, but the presence of these contaminants could lead to precipitation or aggregation, which may impede the transfer devices and/or jeopardize the integrity of the library. Furthermore, altered concentrations of drug or reagent may lead to toxicity and, consequently, the loss of viable cell-based assays, which comprise at least 60-70% of high-throughput screening efforts, according to recent estimates. Thus, the need for accurate fluid volume transfer is tightly correlated with the need for accuracy through subsequent steps of the liquid transfer procedure.

Parallel Synthesis Technologies, the assignee herein, manufactures and markets a series of microarray spotting pin devices from silicon that are inexpensive and possess characteristics that make them superior for transferring small volumes of liquid, when compared to the formerly used metal spotting pin devices. These pin devices operate by drawing fluid upward into an internal reservoir and subsequently depositing small droplets of the fluid upon repeated application of the pin device to a substrate. The transfer of fluid from pin to substrate during microcontact printing is passive and the pin tip must be touched to the surface to affect transfer. The pin devices are manufactured through well characterized, readily available and parallel micromachining processes that allow for inexpensive, bulk production of multiple identical structures. The pins exhibit outstanding consistency in terms of low coefficients of variance and highly reproducible spot morphology during fluid deposition. Furthermore, the well known properties of silicon and its associated surface chemistry, allow the pins to function analogously to glass, and as such, can be derivatized by a variety of methods, thus expanding upon their versatility and usefulness for handling any type of solution or reagent.

Accordingly, there is a need for an inexpensive, high-throughput fluid transfer device that is capable of delivering fixed, sub-microliter volumes of fluid from one location to another.

### SUMMARY

Disclosed herein is a fluid transfer device comprising a body and a sample holding reservoir formed in the body. The reservoir has a depth that extends transverse to a longitudinal axis of the body. The sample holding reservoir is capable of imbibing a fixed quantity of fluid from a fluid source and dispensing the fixed quantity of fluid therefrom at a destination.

A method is disclosed herein for making a fluid transfer device including a pin like body, and a sample holding reservoir formed in the body, the reservoir having a depth that extends transverse to a longitudinal axis of the body, the sample holding reservoir is capable of imbibing a fixed quantity of fluid from a fluid source and dispensing the fixed quantity of fluid therefrom at a destination. The method comprises providing a substrate, forming a patterned etch mask on the substrate, the pattern etch mask defining the body and sample holding reservoir of the fluid transfer device, the pattern etch mask allowing portions of the substrate to be exposed, and etching the exposed portions of the substrate to define the fluid transfer device.

A method is disclosed herein for making a fluid transfer device including a body, and a sample holding reservoir formed in the body, the reservoir having a depth that extends transverse to a longitudinal axis of the body, the sample holding reservoir being capable of imbibing a fixed quantity of fluid from a fluid source and dispensing the fixed quantity of fluid therefrom at a destination. The method comprises forming a positive mold of the fluid transfer device using a micromachining process, forming a negative mold of the fluid transfer device from the positive mold using an electroforming process, and forming the fluid transfer device from a polymeric material in the negative mold.

A method is disclosed herein for transferring a fluid. The method comprises providing a fluid transfer device including a body, and a sample holding reservoir formed in the body, the reservoir having a depth that extends transverse to a longitudinal axis of the body; immersing the fluid transfer device in a fluid source, the sample holding reservoir of the fluid transfer device imbibing a fixed quantity of source fluid from the fluid source; and dispensing the fixed quantity of the source fluid from the sample holding reservoir at a destination.

### BRIEF DESCRIPTION OF THE DRAWINGS

FIGS. 1A-1F collectively show an embodiment of a fluid transfer device.

FIGS. 2A and 2B collectively show another embodiment of the fluid transfer device.

FIGS. 3-11 show further embodiments of fluid transfer devices.

FIGS. 12A-12E show embodiments of a method for fabricating silicon versions of the fluid transfer devices.

FIGS. 13A-13D show an embodiment of a method for fabricating polymer versions of the fluid transfer devices.

FIGS. 14A-14D show an embodiment of gas or liquid chromatography sample loading using the fluid transfer device.

FIGS. 15A-15C show an embodiment of a method for reformatting libraries of chemical compounds or other catalogued substances using the fluid transfer device.

### DETAILED DESCRIPTION OF THE INVENTION

Disclosed herein are devices and methods for handling, transferring and dispensing fluid, particularly, small volumes of fluid. The devices (hereinafter fluid transfer devices or FTDs) are particularly useful for passively uptaking and transferring selected volumes of fluids from a source fluid to a destination fluid.

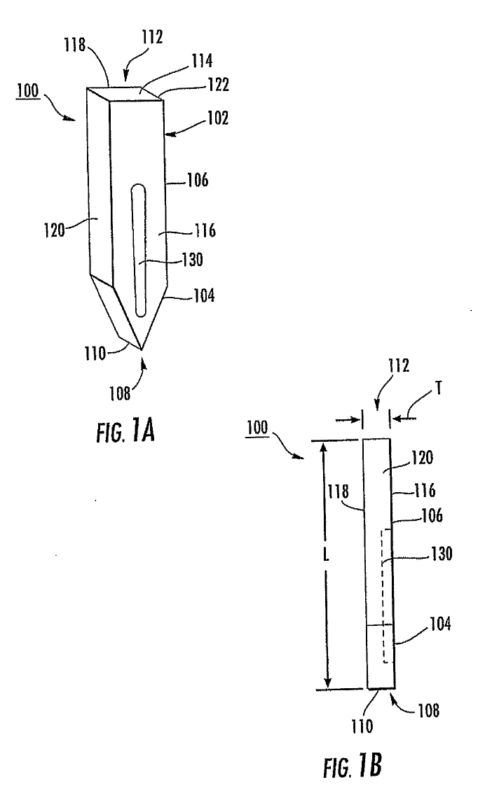

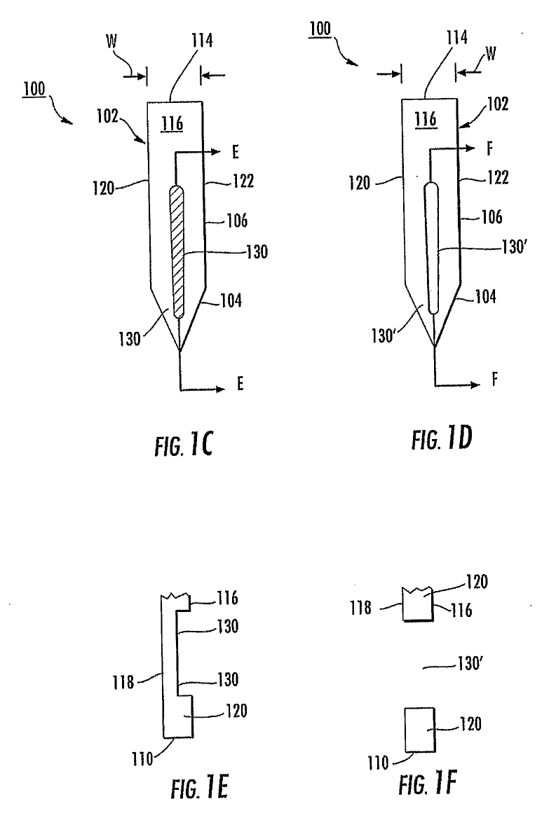

FIGS. 1A-1F collectively show an embodiment of a FTD, denoted by reference character 100. The FTD 100 comprises a pin-shape body 102 formed by tapered and non-tapered sections 104 and 106. The tapered section 104 tapers toward a first end 108 of the FTD body 102 and forms a sharp edge 110 and the non-tapered section 106 of the FTD body 102 defines a generally planar end surface 114 at a second end 112 of the FTD body 102. The FTD body 102 further includes first and second generally planar face surfaces 116 and 118, and opposing first and second generally planar lateral surfaces 120 and 122. The FTD body 102 may have a generally rectangular or square transverse profile. The second end 112 of the FTD body 102 may be adapted for mounting the FTD 100 in a holder (not shown). The holder may be similar to the holders used for mounting conventional spotting pins to a printing head. The printing head may used for immersing the one or more FTDs held by the holder into the source fluid to imbibe the source fluid, transferring the FTDs to the destination fluid, and immersing the FTDs in the destination fluid to complete the fluid transfer. In some applications, it may be desirable to merely drop the FTDs containing the imbibed source fluid into the destination fluid to complete the fluid transfer. In some embodiments, as shown in FIGS. 9-10, the FTD 900, 1000, 1100 may include an outwardly extending holding flange 903, 1003, 1103 for manual or automatic handling of the FTD.

The tapered section 104 of the FTD body 102 substantially prevents fluid from adhering to the exterior surfaces of the FTD body 102 during fluid uptake (imbibing). The longer and more pointed or sharp the tapered section 104, the less likely fluid will adhere to the exterior surfaces of the FTD body 102 during fluid imbibing. The tapered section 104 of the FTD body 102 is also provided for puncturing a protective membrane or closure that may be covering the source fluid or destination fluid.

The FTD 100 further includes a sample holding reservoir 130 formed in the FTD body 102. In the embodiment shown in FIGS. 1A-1F, the sample holding reservoir 130 is formed in the first face surface 116 of the FTD body 102. The sample holding reservoir 130 may extend partially through the FTD body 102, as shown in FIG. 1E, thereby forming a “partially open reservoir” of a fixed capacity. In an alternative embodiment, as shown in FIG. 1F, a sample holding reservoir 130′ is provided which extends entirely through the FTD body 102 to the second face surface 118, thereby forming a “fully open reservoir” of a fixed capacity. The fully open sample holding reservoir 130′ provides a greater fixed sample holding capacity than the partially open sample holding reservoir 130. This, in turn, increases the amount of fluid that can be transferred from the source to the destination by the FTD 100.

The FTD 100 may have a length L between about 0.5 mm and 50 mm, a width W between about 0.1 mm and 10 mm, and a thickness T of less than 1 mm. One of ordinary skill in the art will of course appreciate that other embodiments of the FTD 100 including the embodiments described further on, may have other dimensions. For example, the dimensions of the FTD may be varied to accommodate different sizes of source and destination vessels, reservoirs, and containers.

The sample holding reservoir of the FTD may be any suitable shape. In the preferred embodiment shown in FIGS. 1A-1F, the sample holding reservoir 130, 130′ has an elongated shape that tapers toward the first end 108 of the body 102 along a longitudinal axis of the body 102. The tapered shape enables a fluid to be drawn into the reservoir and stored therein Partially open versions of the tapered reservoir may have a constant or variable depth which is less than the thickness of the body along the length of the reservoir. Variable depth tapered reservoirs may include steps or undulations.

In other embodiments, the FTD 100 may include two or more of the elongated and tapered sample holding reservoirs 130 or 130′, wherein each reservoir is provided for holding a fixed quantity of fluid. In still other embodiments, the sample holding reservoir(s) may have a round, elliptical or oval shape. In yet other embodiments, the sample holding reservoir(s) may have a square or rectangular shape. Fluid transfer efficiency is maximized with reservoirs that do not have sharp or pointed corners where the sample may tend to adhere to during transfer, and are easier to clean than reservoirs with sharp or pointed corners.

FIGS. 2A and 2B collectively show another embodiment of the FTD, denoted by reference character 200. FTD 200 is similar to FTD 100 shown in FIGS. 1A-1C and 1E, except that FTD 200 includes two opposing, partially open sample holding reservoirs 230.

FIG. 3 shows another embodiment of the FTD, denoted by reference character 300. FTD 300 is similar to FTD 100 shown in FIGS. 1A-1F, except that FTD 300 includes two or more circular-shape sample holding reservoirs 330. Each of the reservoirs 330 may be partially open designs similar to reservoir 130 in FIG. 1E or fully open designs similar to reservoir 130′ in FIG. 1F. In an alternative embodiment, the FTD 300 may include one or more partially open, circular-shape sample holding reservoirs and one or more fully open, circular-shape sample holding reservoirs.

FIG. 4 shows a further embodiment of the FTD, denoted by reference character 400. FTD 400 is similar to FTD 100 shown in FIGS. 1A-1F, except that FTD 400 includes one or more elliptical-shape sample holding reservoirs 430. Each of the reservoirs 430 may be partially open designs similar to reservoir 130 in FIG. 1E or fully open designs similar to reservoir 130′ in FIG. 1F. In an alternative embodiment, the FTD 400 may include one or more partially open, elliptical-shape sample holding reservoirs and one or more fully open, elliptical-shape sample holding reservoirs.

FIG. 5 shows another embodiment of the FTD, denoted by reference character 500. FTD 500 is similar to FTD 100 shown in FIGS. 1A-1F, except that FTD 500 includes one or more elliptical-shape sample holding reservoirs 530a and one or more circular-shape sample holding reservoirs 530b. Each of the reservoirs 530a and 530b may be partially open designs similar to reservoir 130 in FIG. 1E or fully open designs similar to reservoir 130′ in FIG. 1F. In an alternative embodiment, the FTD 500 may include one or more partially open, elliptical-shape and/or circular-shape sample holding reservoirs and one or more fully open, elliptical-shape and/or circular-shape sample holding reservoirs.

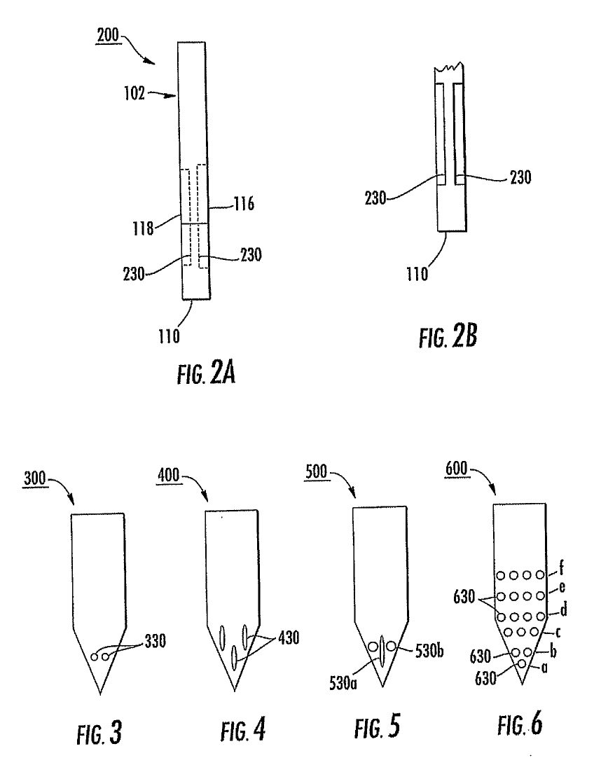

FIG. 6 shows yet another embodiment of the FTD, denoted by reference character 600. FTD 600 is similar to FTD 100 shown in FIGS. 1A-1F, except that FTD 600 includes a plurality of sample holding reservoirs 630 disposed in a plurality rows in the tapered and non-tapered sections 104 and 106 of the FTD body 102. In the shown embodiment, the sample holding reservoirs have the earlier described circular-shape. In other embodiments (not shown), the sample holding reservoirs may be other suitable shape including without limitation the earlier described elliptical shape. In still other embodiments, the sample holding reservoirs in the tapered and non-tapered sections 104 and 106 may have different shapes, e.g., circular and elliptical. Moreover, each of the reservoirs 630 may be partially open designs similar to reservoir 130 in FIG. 1E or fully open designs similar to reservoir 130′ in FIG. 1F. The FTD 600, in another embodiment, may include one or more partially open, circular-shape sample holding reservoirs and one or more fully open, circular-shape sample holding reservoirs.

Each row of sample holding reservoirs in the FTD 600 provides an incremental increase in the total reservoir volume of the FTD 600 and allows a user to selectively vary the total quantity of fluid that the FTD 600 transfers from the source to the destination by controlling the depth to which the FTD 600 is immersed in the source fluid. For example, if FTD 600 is selectively immersed in the source fluid up to row d, then the total quantity of fluid transferred to the destination will be equal to the total reservoir volume of the sample holding reservoirs in rows a-d. In another example, if FTD 600 is selectively immersed in the source fluid up to row f, then the total quantity of fluid transferred to the destination will be equal to the total reservoir volume of the sample holding reservoirs in rows a-f.

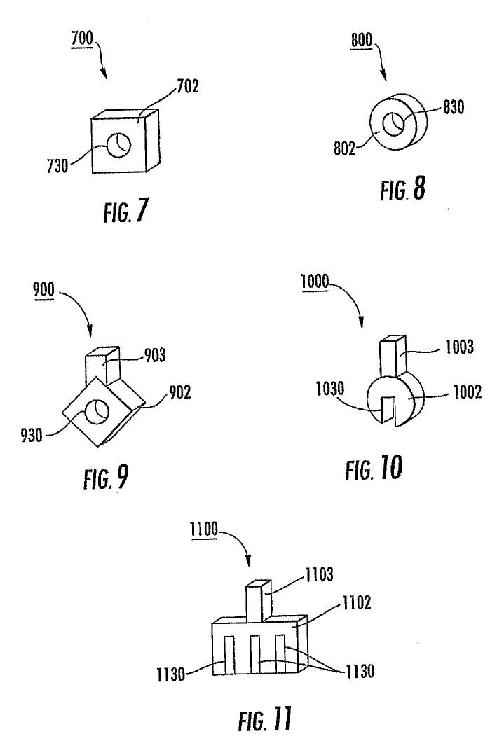

FIGS. 7 and 8 show other embodiments of the FTD, denoted by reference characters 700 (FIG. 7) and 800 (FIG. 8). Unlike the previous embodiments of the FTD, which have pin-shape bodies, FTDs 700 and 800 have square-shape or circular-shape bodies 702 and 802. Although the FTDs 700 and 800 shown in FIGS. 7 and 8 include circular-shape sample holding reservoirs 730 and 830, other embodiments of these FTDs may have sample holding reservoirs with other shapes.

FIG. 9 shows an embodiment of the FTD, denoted by reference character 900 having diamond-shape body 902, a circular-shape sample holding reservoir 930 and an outwardly extending holding flange 903 for manual or automatic handling of the FTD.

FIG. 10 shows an embodiment of the FTD, denoted by reference character 1000 having circular-shape body 1002, an elongated, tapered sample holding reservoir 1030 and an outwardly extending holding flange 1003 for manual or automatic handling of the FTD.

FIG. 11 shows an embodiment of the FTD, denoted by reference character 100 having rectangular-shape body 1102, three elongated, tapered sample holding reservoirs 130 and an outwardly extending holding flange 1103 for manual or automatic handling of the FTD.

The FTDs may be made of a semiconductor material, a glass, a metal, a ceramic, a polymer, and any other material that can be micromachined. In a preferred embodiment, the FTDs described herein are made of silicon and fabricated from silicon wafers using conventional silicon micromachining methods such as photolithography, wet etching, and Deep Reactive Ion Etching (DRIE). Silicon micromachining generally involves coating a silicon (Si) wafer to be micromachined with a masking material and patterning the masking material using photolithography followed by selective removal of regions of the Si wafer not covered by the patterned masking material, using an etching method. Etching is the primary means by which the third dimension of a micromachined structure is obtained from a planar photolithographic method. There are generally two main types of etching methods used for micromachining, namely wet etching and dry/plasma etching method.

In both etching methods, the pattern to be etched may be defined by a photolithographic method. In photolithography, CAD software may be used to design a photomask with the appropriate dimensions for the FTDs and their associated sample holding reservoirs. The mask design may be used to prepare an image in chromium on a long wavelength UV transparent glass substrate, i.e., a chromium on glass photomask. A layer of positive photoresist (positive means that the irradiated portion of the photoresist is dissolved in the development step) may be spin coated onto a silicon wafer, which may be four (4) inches in diameter. The photoresist may be soft-baked for 1-2 minutes at 90°. The photomask is then placed between the photoresist layer and a UV light source, and the photoresist is irradiated. After a subsequent development procedure to remove photoresist (with photoresist developer) and any exposed SiO₂ (with HF) from the wafer surface, the wafer is then etched to remove silicon from the exposed areas.

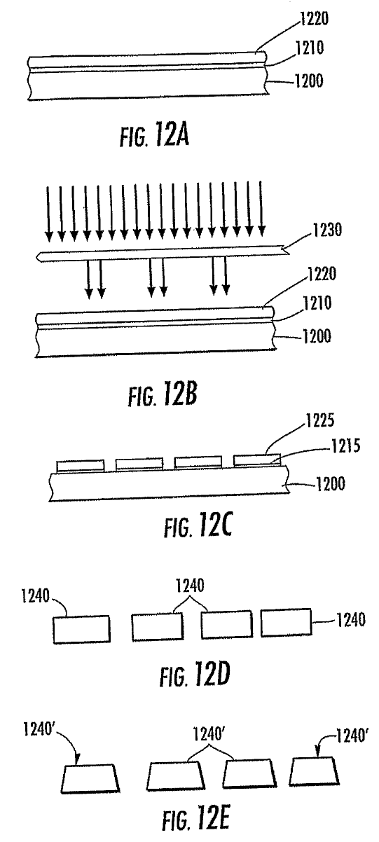

The most selective dry/plasma etching method is Deep Reactive Ion Etching (DRIE), which is noted for its ability to etch features with very high aspect ratios. This plasma based method rapidly pulses etchant and passivator gasses alternatively over the Si wafer. FIGS. 7A-7D illustrate an embodiment of a method for fabricating silicon FTDs. In the method, a single crystal Si wafer 700 having a (100) or (110) orientation is oxidized to form a SiO₂ layer 710 thereon and a photoresist layer 720 is formed over the SiO₂ layer 710 using a spin coating technique. FIG. 12A shows the wafer 1200 after performing the oxidation and spin coating. In FIG. 12B, a photomask 1230 is then placed between the photoresist layer 1220 and a UV light source (not shown), and portions of the photoresist layer 1220 are irradiated.

The irradiated portions of the photoresist layer 1220 are then removed from the wafer 1200. Portions of the SiO₂ layer 1210 exposed by the removal of the irradiated portions of the photoresist layer 1220 are removed from the wafer surface by etching the exposed portions of the SiO₂ layer 1210 with a fluoride based etch (also known as a Buffered Oxide Etch). The fluoride based etch exposes the silicon beneath the SiO₂ layer 1210. FIG. 12C shows the wafer 1200 after removal of the irradiated portions of the photoresist layer 1220 and exposed portions of the SiO₂ layer 1210.

The wafer structure shown in FIG. 12C is then etched using remaining portions 1225 of the photoresist layer 1220 and the remaining portions 1215 of the SiO₂ layer as etch stops. Etching is preferably performed using the earlier described DRIE process. After completion of the DRIE process, the remaining portions 1225 and 1215 of the photoresist layer 1220 and SiO₂ layer are removed from etched wafer portions, which are now the FTDs. FIG. 12D shows the FTDs 1240 produced by the DRIE process after removal of the etch stop portions 1225 and 1215 of the photoresist layer 1220 and SiO₂ layer.

The remaining portions 1225 of the photoresist layer 1220 and the remaining portions 1215 of the SiO₂ layer 1210 serve as etch stops in the DRIE process, as both the layers etch slower than silicon. Hence, either a SiO₂ layer or a photoresist layer or both can be used as etch stops in the DRIE process. The DRIE etch process removes the portion(s) of the Si wafer not masked by the etch-resistant SiO₂ and/or photoresist layers. By employing DRIE method, it is possible to make cuts perpendicular to the surface of the Si wafer in an anisotropic fashion and form sample holding reservoirs having a depth:width ratio (aspect ratio) of 10 or more with nearly vertical sidewalls. Essentially any arbitrary shape can be cut into the silicon in this manner limited only by the resolution of the photolithographic process.

In an alternate embodiment, the wafer 1200 shown in FIG. 12C may be etched in aqueous KOH at approximately 80° C. The KOH etch attacks the silicon <100> planes many times faster than the <111> planes and may be used to etch square pits with 54.7° <111> sidewalls into the (100) Si wafer. The remaining portions 1215 of the SiO₂ layer 1210 serve as an etch stop (hard mask) for the KOH etch process. FIG. 12E shows the FTDs 1240′ produced by the wet KOH etch process after removal of the etch stop portions 1225 and 1215 of the photoresist layer 1220 and SiO₂ layer. A primary advantage of the wet etching method is that many wafers can be inexpensively etched in parallel. Wet etching, however, only etches along certain crystallographic planes and not at arbitrary angles.

In some embodiments, the internal and external surfaces of the FTDs may be further modified by chemical treatments, such silanization, to alter the hydrophobicity/hydrophilicity of the FTD's internal and external surfaces.

In another preferred embodiment, the FTDs described herein may be made of any suitable polymer, including without limitation, polycarbonates, polyacrylics, polymethyhnethacrylates, polyolefins, polyetherketones or other thermoplastic polymers, to further decrease the cost of the FTDs. Such inexpensive FTDs may be used once and disposed of. In one embodiment, such FTDs may be fabricated from a micromachined silicon master or positive mold. The silicon master mold may be fabricated using the silicon micromachining methods described above for making the silicon FTDs, as the silicon master mold is essentially the same as the final polymer FTDs, and will be used for the subsequent fabrication of the polymeric FTDs. The fine features on the polymeric FTDs, like the features of the silicon FTDs described above, are ultimately derived from the accuracy inherent in the silicon micromachining fabrication and photolithography processes. An electroformed mold is electrolytically deposited using the micromachined silicon (which is suitably sensitized) as a cathode. The electroformed mold, in one embodiment, may be made of a Co—Ni or Ni—Fe alloy. The silicon is removed from this negative electroform and the electroform is used to compression mold, resin cast or emboss the FTD(s) from a polymer. Silicon molds are very inexpensive to prepare and are capable of containing much finer features than molds prepared by traditional machining techniques.

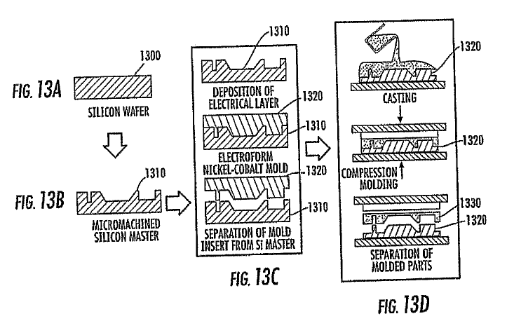

FIGS. 13A-13D illustrate an embodiment of a method for fabricating polymer FTDs. In FIG. 13A, a blank Si wafer 1300 is provided. In FIG. 13B, the Si wafer 1300 is micromachined to prepare a Si master mold 1310 using the silicon micromachining methods described earlier, or any other suitable silicon micromachining method. In FIG. 13C, a metal mold 1320 is formed in the Si master mold 1310. The metal mold 1320 may be made of nickel-cobalt. In FIG. 13D, polymer FTD(s) 1330 are then molded in the metal mold 1320. Molding may be implemented using any suitable polymer forming method. In one embodiment, a resin casting technique where the polymer precursors and a polymerization catalyst are mixed and poured into the mold 1320 which may be heated to accelerate the reaction, as shown in FIG. 13D. Other polymer forming methods, such as compression molding, hot embossing, injection molding and the like may also be used.

In other embodiments, silicon FTDs may be fabricated from a silicon wafer using UV or X-ray lithography and photomasks followed by wet etching and/or reactive ion etching (RIE) of the silicon wafer.

In yet other embodiments, silicon, glass, ceramic and metal FTDs may be fabricated using micro-grit, wet blasting, and/or laser cutting methods.

In further embodiments, metal FTDs may be fabricated from metal sheets using laser cutting and/or photo-chemical etching methods.

In still further embodiments polymer FTDs may be fabricated from polymer films and/or sheets using laser cutting methods.

The FTDs described herein are capable of transferring small (femtoliters to microliters) volumes of fluid from a fluid source to a fluid destination. In one embodiment, a FTD of a selected volume, which is determined based on the size and number of sample holding reservoirs in the FTD, is submerged in a fluid source to be imbibed and transferred to a destination fluid.

The fluid source may be contained in or by any suitable containment medium including, without limitation, a vessel, a tube, a well of a microtiter plate, and any suitable substrate where the source fluid is a droplet suspended atop of the substrate. The fluid source contained in or by the containment medium (e.g., a high well density microtiter plate) may be covered with a protective membrane or closure including, without limitation, a metal foil, a plastic film, and any other closure capable of being punctured or pierced by the tapered section of the FTD.

As the FTD is submerged into the fluid source, the tapered section of the FTD punctures or pierces the closure thereby gaining access to the fluid source. The intrinsic strength of the FTD enables it to puncture the cover without fracturing.

After sample uptake, the FTD is submerged into the destination fluid contained in or by a containment medium including, without limitation, a vessel, tube, well of a microtiter plate, and substrate, whereupon the source fluid contained within the sample holding reservoir(s) of the FTD diffuses from the FTD into the surrounding destination fluid contained in or by the destination containment medium. Alternatively, the transferred source fluid may be drawn from the FTD by a vacuum and subsequently combined with the destination fluid.

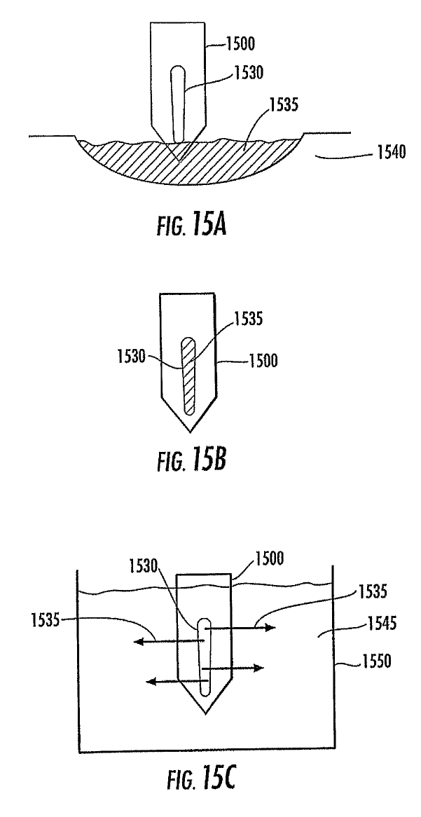

In a preferred embodiment, one or more FTDs are used for reformatting libraries of chemical compounds or other catalogued substances. As shown in FIG. 15A, a FTD 1500 imbibes of first fluid 1535 upon submersion into a fluid source. The fluid source may be contained in a high throughput format medium 1540, such as a 96, 384, 1536-well microtiter plate. The fluid source containment medium 1540 may be covered with the earlier described protective membrane or closure (not shown). After removal from the fluid source, the sample holding reservoir 1530 of the FTD 1500 contains the imbibed source fluid 1535, as shown in FIG. 15B. In FIG. 15C, the FTD 1500 is submerged into a destination containment vessel 1550 which contains a destination fluid 1545, whereupon the source fluid 1535 contained within the sample holding reservoir 1530 of the FTD 1500 diffuses from the FTD 1500 into the destination fluid 1545 contained in the destination containment vessel 1550.

FTDs made from silicon have surfaces coated with SiO₂. Accordingly, the surfaces of the silicon FTDs have properties which are those of SiO₂. As such, they have negligible interactions with transferred substances and are tolerant to a wide variety of chemical and physical conditions. Furthermore, SiO₂ coated surfaces can be heated to 1000° Celsius. without damage. At these temperatures, organic contaminants are oxidized and eliminated from the FTD's external and internal surfaces, allowing the FTDs to be cleaned using any suitable deep cleaning method, such as high temperature cleaning, plasma cleaning, and/or any suitable chemical cleaning method.

FTDs made from a polymer are likewise useful for a wide range of fluid handling operations. Due to their ability to be inexpensively fabricated from master molds, polymer FTDs are less expensive than their silicon counterparts. Polymer FTDs are used analogously to the silicon FTDs when compatible with the substances to be handled, and can be reused or treated as disposable. This latter property renders polymer FTDs extremely useful for handling radioactive and like substances which require special containment or disposability.

Due to the intrinsic strength of silicon and/or polymer, the FTDs easily puncture the protective membranes or closures covering the fluid source. The small dimensions and high tolerances of the FTDs also allow a large number of FTDs to be packed together at sufficiently high densities to enable their use in ultra high-throughput format. This property is especially important for minimizing the time, materials, and labor required to format and assay the massive libraries of compounds that are being examined for therapeutic or research applications. Finally, the ease of manufacturing and availability of silicon and/or polymer ensure that FTDs can be manufactured inexpensively and in sufficient quantities to support ongoing and future efforts in drug discovery and other applications.

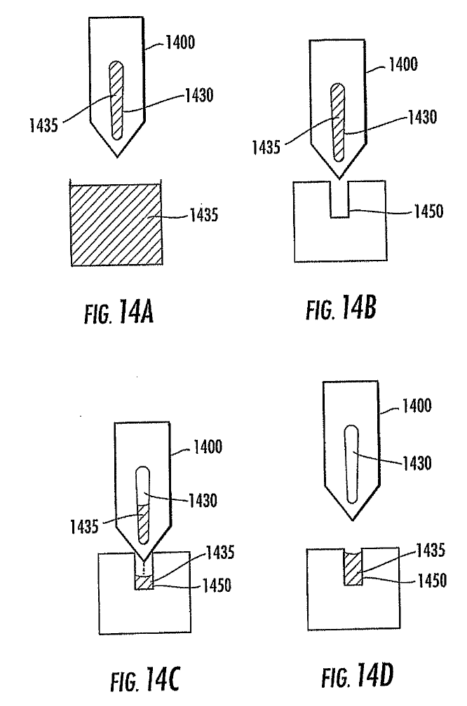

In another embodiment, as collectively shown in FIGS. 14A-14D, a FTD 1400 may be used for transferring a fluid 1435 from a source to a sample loading port 1450 of an analytical device (not shown). The sample holding reservoir 1430 of the FTD 1400 is loaded with a source fluid sample 1435 in FIG. 14A. The FTD 1400 is brought into contact with the sample loading port 1450, which is under a vacuum as shown in FIG. 14B. The vacuum draws the entire sample 1435 from the sample holding reservoir 1430 of the FTD 1400 and into the analytical device for subsequent analysis, as shown in FIGS. 14C and 14D.

In one embodiment, the analytical device may be a gas or liquid chromatography column. Gas chromatography is an extremely useful technique that is widely used in nearly all sectors of human activity. For example, many commercial products including, without limitation, cosmetics, food products, pesticides, and plasticizers, are analyzed for purity using chromatography. Coal and petroleum products are also routinely analyzed by gas chromatography. Moreover, chromatography is essential for diagnostics and sample testing in such diverse areas as police forensics laboratories and hospitals. Likewise, for the analysis of material of insufficient volatility for gas chromatographic analysis, liquid chromatography is extensively used. With such wide use and broad applications, there is an ever increasing need for rapid, inexpensive, and accurate methodologies for transferring samples into the capillary devices of the chromatography instrument that comprise the stationary phase of the gas or liquid chromatography instrument. The small dimensions, close tolerances, and extreme versatility of the FTDs described herein confer the same advantages and benefits for gas chromatography sample formatting as they do for compound library reformatting.

The FTDs may also be used in a variety of other fluid transfer applications, including but not limited to, assay development, miniaturization and reformatting, and any other procedure or process requiring manipulation of submicroliter volumes of fluid.

Most technologies available for small volume, high-throughput fluid transfer applications utilize active mechanisms to aspirate and dispense samples. In contrast, the FTDs described herein perform passive uptake and dispensing, using only physical, relative wetting and the thermodynamic properties of the FTDs and fluids themselves to function. Unlike microarray spotting pins, which imbibe a fixed volume of a fluid source and subsequently deposit fractions of that volume upon repeated application to a substrate, the FTDs described herein imbibe a fixed volume of a fluid source and subsequently dispense all of the fluid into a destination fluid or a sample loading port of an analytical instrument.

Table 2 below compares silicon and polymer FTDs to conventional grooved metal pins machined from steel or other metal/metal alloys.

TABLE 2

| Feature/ | | | |
|---|---|---|---|
| Benefit | Silicon | Polymer | Metal |
| Cost Of | 25% cost of metal | 10-25% cost | expensive |
| Manufacture | tools | of metal tools | |
| Ease Of Mass | simple; parallel | simple; | difficult; serial |
| Production | fabrication | parallel | production |
| | | fabrication | |
| Ease Of | simple, thorough | disposable | difficult |
| Cleaning | with butane torch | | |
| Pacing | 1 to 1536 or more | 1 to 1536 or | 1 to 384 samples |
| Density | samples at once | more samples | |
| | | at once | |
| Uniformity | identical | identical | variables |
| Durability | high; hard, smooth | soft; | moderate, |
| And Strength | surface | disposable | somewhat softer |
| | | | than silicon |
| Surface | well-characterized, | widely useful, | less |
| Properties | easy to derivatize | but may need | well-characterized |
| | | derivatization | |
| | | for certain | |
| | | substances | |

In general, both silicon and polymer FTDs are far less expensive than conventional metal pins due to their ability to be mass produced in parallel or bulk. The highly precise micromachining process also allows accurate volumetric uptake based on size of their reservoir features, whereas metal pins must be tested and binned individually in order to determine their actual volumetric uptake in practice. The extremely high tolerances and micron scale features that can be engineered into silicon and polymer FTDs allow them to be packed into a FTD holder at a higher density than that possible with the metal pins, thereby increasing the level of throughput that can be obtained. In addition, silicon and polymer FTDs possess excellent properties that render them particularly suitable for handling substances of a wide range of properties. Silicon FTDs possess surfaces that are functionally SiO₂, and as such are fairly inert to a range of chemical and physical abuses. Additionally, a great deal is known about surface chemistry of silicon, and thus an extensive repertoire of surface modifications and treatments are available to expand the utility and versatility of the FTDs. The polymer FTDs, because of their low cost of manufacture, may be effectively treated as disposable, a feature that makes them extremely useful for handling radioactive liquids and other fluids that require special handling. Because the FTDs use passive diffusion to accomplish fluid transfer, it is much less likely that a radioactive or caustic substance will be aspirated or splashed into the automated machinery that may be manipulating the pipettes.

It should now be apparent to persons skilled in the art that the FTDs described herein are capable of achieving highly accurate and precise fluid transfer at any throughput, are useful for any application that requires liquid handling in the range of 1 femtoliter to 10 milliliters, and are particularly useful for handling volumes in the picoliter to millimeter range.

The following examples illustrate some exemplary applications of the FTDs described herein.

### EXAMPLE 1

### Compound Library Reformatting Procedure for Use in a Cellular Assay

In example 1, a company that maintains a library of 200,000 chemical compounds wants to test the effects of these substances on the motility of bacterial flagella. An automated system with a device that holds 1536 tightly packed, 10 nl-volume silicon FTDs is lowered into a source plate containing 1536 different chemicals. The FTDs puncture the foil lid of the plate and are submerged into the liquid, whereby they imbibe 10 nl of the liquid. The FTDs are thereby moved to a destination 1536-well microtiter dish. The FTDs are once again lowered and subsequently submerged into 50 microliters of liquid growth medium, whereby the contents of the FTDs diffuse out into their surroundings. The FTDs are transferred to a cleaning station where they are rinsed in water and dried. The entire procedure is then repeated with a new source plate, until all 200,000 compounds have been diluted into cell culture medium. After the drugs have thus been diluted into cell growth medium, the source plate is changed to a dish of bacterial culture, and the 10 nl FTDs are used again to transfer samples of the bacteria to the drug/medium conditions. Upon completion of this procedure, FTDs are placed under a butane torch to remove all traces of organics and cell debris.

### EXAMPLE 2

### Gas Chromatography Procedure to Detect Food Spoilage

In example 2, a large food packaging facility wants to determine the most suitable preparation method for extending the shelf life of their product. Hundreds of samples of chicken are prepared in different ways, ranging from different grades of mincing, varying temperatures, an adjusting preservative types and levels. The preparations are then dissolved in an appropriate solvent, and FTDs for measuring 50 nl are submerged into the source vials to imbibe the corresponding samples. FTDs are then transferred to a vacuum receptacle and touched to the surface, where their contents are subsequently drawn down into capillaries which flow into the gas chromatograph. The instrument is utilized to measure hexanal levels or other indicators of meat spoilage.

### EXAMPLE 3

### Radio-Labeling

In example 3, a radiology laboratory wants to screen the effects of drugs on the metabolic processing of radioactive substances in various tissues. Because the isotopes are dangerous, handling is kept to a minimum and automated equipment is used as much as possible. After tissue samples have been arrayed into 96-well microtiter plates containing 50 microliters of phosphate buffered saline, an array of plastic 100 nl FTDs is loaded onto the arm of a robot. The FTDs are submerged into a source plate of a radioactive tracer substance, transferred to the destination wells, and lowered into the receiving solutions whereby the radioactive substance diffuses into the saline. The FTDs are ejected from the automated device into radioactive waste. A second set of plastic FTDs are used to transfer drugs from a 96-well format compound library to the receiving wells of radioactive tissues. These FTDs are also placed in the radioactive waste. Each subsequent manipulation of the samples is contaminated with radiation, and thus will be disposed of appropriately. Because the FTDs do not actively aspirate sample, no microscopic droplets are accidentally drawn into the robot, minimizing the potential need to decontaminate the equipment.

### EXAMPLE 4

### Assay Miniaturization

In example 4, a genetic laboratory wants to convert their existing 96 well format PCR assay to a miniaturized, 1536-well format in order to conserve reagents and samples. FTDs are chosen with volumes corresponding to 10% of what they had been using previously. PCR reactions are set up by using FTDs to transfer each component of the reaction into receiving wells of water.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A fluid transfer device comprising:
a body; and
a sample holding reservoir formed in the body, the reservoir having a depth that extends transverse to a longitudinal axis of the body,
wherein the sample holding reservoir is capable of imbibing a fixed quantity of fluid from a fluid source and dispensing the fixed quantity of fluid therefrom at a destination.

2. The fluid transfer device of claim 1, wherein the sample holding reservoir extends partially through the body.

3. The fluid transfer device of claim 1, wherein the sample holding reservoir extends entirely through the body.

4. The fluid transfer device of claim 1, wherein the body is made from a semiconductor material.

5. The fluid transfer device of claim 4, wherein the semiconductor material is silicon.

6. The fluid transfer device of claim 1, wherein the body is made from a polymer material.

7. The fluid transfer device of claim 1, wherein the body is made from a ceramic material.

8. The fluid transfer device of claim 1, wherein the body includes a tapered section and a non-tapered section.

9. The fluid transfer device of claim 8, wherein the sample holding reservoir is disposed in the tapered section of the body.

10. The fluid transfer device of claim 8, wherein the sample holding reservoir is disposed in the non-tapered section of the body.

11. The fluid transfer device of claim 1, wherein the sample holding reservoir has a shape without sharp, pointed corners.

12. The fluid transfer device of claim 1, further comprising at least a second sample holding reservoir.

13. The fluid transfer device of claim 12, wherein the sample holding reservoirs are disposed on opposite sides of the body.

14. The fluid transfer device of claim 12, wherein the sample holding reservoirs are disposed on a same side of the body.

15. The fluid transfer device of claim 14, wherein at least one of the sample holding reservoirs extends entirely through the body.

16. The fluid transfer device of claim 14, wherein at least one of the sample holding reservoirs extends partially through the body.

17. The fluid transfer device of claim 1, wherein the sample holding reservoir is one of an array of sample holding reservoirs formed in the body.

18. The fluid transfer device of claim 12, wherein the samples holding reservoirs are disposed at different longitudinal locations of the body thereby allowing the fixed quantity of the fluid imbibed by the fluid transfer device to be controlled by a depth to which the fluid transfer device is immersed in the fluid source.

19. The fluid transfer device of claim 8, wherein the tapered section of the body is for puncturing a closure covering the fluid source.

20. An apparatus for fluid transfer, the apparatus comprising:
a fluid transfer device comprising:
a body; and
a sample holding reservoir formed in the body, the reservoir having a depth that extends transverse to a longitudinal axis of the body, the sample holding reservoir being capable of imbibing a fixed quantity of fluid from a fluid source and dispensing the fixed quantity of fluid therefrom at a destination.

21. The apparatus of claim 20, further comprising a holder for holding the fluid transfer device.

22. The apparatus of claim 21, further comprising at least a second fluid transfer device, the fluid transfer devices forming an array.

23. The apparatus of claim 20, wherein the sample holding reservoir extends partially through the body.

24. The apparatus of claim 20, wherein the sample holding reservoir extends entirely through the body.

25. The apparatus of claim 20, wherein the body is made from a semiconductor material.

26. The apparatus of claim 25, wherein the semiconductor material is silicon.

27. The apparatus of claim 20, wherein the body is made from a polymer material.

28. The apparatus of claim 20, wherein the body is made from a ceramic material.

29. The apparatus of claim 20, wherein the body includes a tapered section and a non-tapered section.

30. The apparatus of claim 29, wherein the sample holding reservoir is disposed in the tapered section of the body.

31. The apparatus of claim 29, wherein the sample holding reservoir is disposed in the non-tapered section of the body.

32. The apparatus of claim 20, wherein the sample holding reservoir has a shape without sharp, pointed corners.

33. The apparatus of claim 20, further comprising at least a second sample holding reservoir.

34. The apparatus of claim 33, wherein the sample holding reservoirs are disposed on opposite sides of the body.

35. The apparatus of claim 33, wherein the sample holding reservoirs are disposed on a same side of the body.

36. The apparatus of claim 35, wherein at least one of the sample holding reservoirs extends entirely through the body.

37. The apparatus of claim 35, wherein at least one of the sample holding reservoirs extends partially through the body.

38. The apparatus of claim 20, wherein the sample holding reservoir is one of an array of sample holding reservoirs formed in the body.

39. The apparatus of claim 33, wherein the samples holding reservoirs are disposed at different longitudinal locations of the body thereby allowing the fixed quantity of the fluid imbibed by the fluid transfer device to be controlled by a depth to which the fluid transfer device is immersed in the fluid source.

40. The apparatus of claim 29, wherein the tapered section of the body is for puncturing a closure covering the fluid source.

41. A method for making a fluid transfer device including a pin like body, and a sample holding reservoir formed in the body, the reservoir having a depth that extends transverse to a longitudinal axis of the body, the sample holding reservoir being capable of imbibing a fixed quantity of fluid from a fluid source and dispensing the fixed quantity of fluid therefrom at a destination, the method comprising the steps of:
providing a substrate;
forming a patterned etch mask on the substrate, the pattern etch mask defining the body and sample holding reservoir of the fluid transfer device, the pattern etch mask allowing portions of the substrate to be exposed; and
etching the exposed portions of the substrate to define the fluid transfer device.

42. The method of claim 41, wherein the etching step is performed by at least one of a deep reactive ion etching, wet etching, and reactive ion etching.

43. A method for making a fluid transfer device including a body, and a sample holding reservoir formed in the body, the reservoir having a depth that extends transverse to a longitudinal axis of the body, the sample holding reservoir being capable of imbibing a fixed quantity of fluid from a fluid source and dispensing the fixed quantity of fluid therefrom at a destination, the method comprising steps of:
forming a positive mold of the fluid transfer device using a micromachining process;
forming a negative mold of the fluid transfer device from the positive mold using an electroforming process; and
forming the fluid transfer device from a polymeric material in the negative mold.

44. The method according to claim 43, wherein the polymeric material is selected from the group consisting of polycarbonates, polymethylmethacrylates, polyolefins, and polyetherketones.

45. The method according to claim 43, wherein the polymeric material comprises a thermoplastic polymer.

46. A method for transferring a fluid, the method comprising the steps of:
providing a fluid transfer device including a body, and a sample holding reservoir formed in the body, the reservoir having a depth that extends transverse to a longitudinal axis of the body;
immersing the fluid transfer device in a fluid source, the sample holding reservoir of the fluid transfer device imbibing a fixed quantity of source fluid from the fluid source; and
dispensing the fixed quantity of the source fluid from the sample holding reservoir at a destination.

47. The method of claim 46, wherein the destination includes a destination fluid, the fixed quantity of the source fluid diffusing into the destination fluid.

48. The method of claim 46, wherein the destination includes a sample loading port of an analytical device.

49. The method of claim 48, wherein the sample loading port of the analytical device is under a vacuum that withdraws the source fluid from the sample holding reservoir of the fluid transfer device.

50. The method of claim 48, wherein the analytical device is a chromatography device.

51. The fluid transfer device of claim 1, wherein the sample holding reservoir has an elongated tapered shape.

52. The apparatus of claim 20, wherein the sample holding reservoir has an elongated tapered shape.
